(19) United States
(12) Patent Application Publication
(10) Pub. No.: US 2007/0040836 A1
(43) Pub. Date: Feb. 22, 2007

(54) CHOREOGRAPHY RECORDING AND ACCESS SYSTEM

(76) Inventor: Pamela Schickler, Rochester, NY (US)

Correspondence Address: BROWN & MICHAELS, PC;400 M & T BANK BUILDING, 118 NORTH TIOGA ST, ITHACA, NY, 14850, US

(21) Appl. No.: 11/465,955

(22) Filed: Aug. 21, 2006

Related U.S. Application Data
(60) Provisional application No. 60/709,530, filed on Aug. 19, 2005.

(51) Int. Cl. G06T 15/70

(52) U.S. Cl. 345/473; 345/419

(57) ABSTRACT

This invention provides a system for recording, storing and accessing choreographic elements. It includes a data storage medium such as a video disk/DVD allowing storage of and access to sound recordings via speakers or headphones, and video images via a screen display such as a television or computer monitor. The moving video images accessed via the screen display include moving images portraying movements of the dancer(s) to music as seen from above, preferably with icons representing the dancers. These images provide an overview of the movement of a dancer or a group of dancers in relation to each other and the stage as the production proceeds in time to the music. It also includes a clock image providing time increments related to the performance, and performance images as seen from stage front which, once again, show the movement of a dancer or a group of dancers in relation to each other and the stage as the production proceeds in time to the music. Step by step demonstration images can also be accessed for individualized demonstrations of dance steps and sequences. Menus link these various image groups, allowing rapid movement between image types and sequences. Preferably, icon images showing movement from above and views from stage front are available on the same screen simultaneously, with the former providing a contemporaneous overview of what is being shown in the latter.

### REFERENCE TO RELATED APPLICATIONS

This application claims an invention which was disclosed in Provisional Application No. 60/709,530, filed Aug. 19, 2005, entitled “Choreography System”. The benefit under 35 USC §119(e) of the United States provisional application is hereby claimed, and the aforementioned application is hereby incorporated herein by reference.

### FIELD OF THE INVENTION

The invention pertains to the field of choreography. More particularly, the invention pertains to a software system for recording and accessing choreographic elements for choreographic works in a readily utilizable form and format.

### BACKGROUND OF THE INVENTION

Choreography (also known as dance composition) is an art form involving the sequenced organization of dance and/or bodily movements. It can involve only a single dancer, but more often involves groups of dancers in coordinated routines calculated to make an esthetic and artistic statement or impression in time with and in conjunction with a musical score/composition.

The process of creating choreography for a dance production is a tedious and complex one. The requirements for a successful production include: Creation of individual movements for each performer; creation of “formations” or placements on stage for each performer at correlated time increments; and creation of a totally integrated production where creative movement, formations and musical score are integrated across all performers to provide an appealing display of artistic demonstration among sometimes numerous performers, all timed to logical increments of musical score.

However, unlike musical compositions, there is no symbolic system (such as exists with musical scores) for recording a choreographic work. Thus, in the past, the only system that has been available and used (since the development of video recording equipment) has been video recording of live performances from stage front. This does not, however, provide a sufficient medium for recording and conveying the nuances of a choreographic work, and is particularly inadequate in conveying all aspects of a work to a dance teacher and the dancers she coordinates for the purposes of performing a choreographic work. Thus, there exists a definite need for an integrated system for recording, storing and accessing choreographic elements for choreographic works in a readily utilizable form and format.

### SUMMARY OF THE INVENTION

My invention provides a system for recording, storing and accessing choreographic elements that is unique in this art area. It integrates all of the above-named elements comprising the tedious and complex process of choreography into a complete package on digital video disk so that the user can see any of the above elements at will for any portion of a unique musical score or time increment. Therefore, the process of my invention has, first, defined each production by its elements and, second, integrated those elements into a final production for the user. In essence, it is a digital package of software linkages of the choreographic elements captured in final form on a video disk. This is extremely useful as it allows a choreographic work to be made accessible, in all pertinent details and with exactitude, to those who may wish to replicate the choreographic work as a live dance production.

In its simplest embodiments, the system of my invention includes a data storage medium such as a video disk/DVD allowing storage of and access to sound recordings via speakers or headphones, and video images via a screen display such as a television or computer monitor. The moving video images accessed via the screen display include moving images portraying movements of the dancer(s) to music as seen from above that provide an overview of the movement of a dancer or a group of dancers in relation to each other and the stage as the production proceeds in time to the music. In preferred embodiments, the system of my invention also includes a clock image providing time increments related to the performance, and performance images as seen from stage front which, once again, show the movement of a dancer or a group of dancers in relation to each other and the stage as the production proceeds in time to the music.

The screen display can potentially provide either of these to the viewer separately or both simultaneously. However, I have found that the best arrangement in terms of meeting the goals of the invention is to provide the viewer/user the option to view (i) the performance images as seen from stage front, (ii) the performance images from above as the main screen image with the performance images from stage front as a sub-screen image being simultaneously presented, (ii) the performance images from stage front as the main screen image with the images from above as a sub-screen image being simultaneously presented, and (iv) step-by-step demonstration images demonstrating particular dance moves and particular dance sequences performed by said at least one dancer. Selection of and movement between these various options is facilitated by provision of a menu image accessible via said screen display, with said menu image containing links for playing the performance and accessing sub-menus for each of the aforesaid options.

### BRIEF DESCRIPTION OF THE DRAWING

FIG. 1 provides a schematic diagram illustrating a method of digital linkage of the invention.

FIG. 2 provides a schematic diagram further illustrating a method of linkage via time increments

FIGS. 3 through 6 provide further information related to implementation of the inventive concept.

FIG. 7A provides an exemplary screen shot illustrating the Main Menu of a preferred embodiment of my choreography storage and access system.

FIG. 7B provides an exemplary screen shot illustrating the Staging Graphic with Performance sub-menu for a preferred embodiment of my choreography storage and access system.

FIG. 7C provides an exemplary screen shot illustrating the Performance with Staging Graphic sub-menu for a preferred embodiment of my choreography storage and access system.

FIG. 7D provides an exemplary screen shot illustrating the Step by Step Break Down sub-menu for a preferred embodiment of my choreography storage and access system.

FIG. 8A through 8G provide exemplary screen shots illustrating sequentially, at time intervals approximately 4 seconds apart, the Performance with Staging Graphic screen images for a choreographed sequence according to the system of a preferred embodiment of my invention.

FIG. 9A through 9G provide exemplary screen shots illustrating sequentially, at time intervals approximately 4 seconds apart, the Staging Graphic with Performance screen images for a choreographed sequence according to the system of a preferred embodiment of my invention. FIGS. 9A through 9G correspond in time exactly or approximately with, respectively, FIGS. 8A through 8G.

FIGS. 10A through 10C provide exemplary screen shots illustrating sequentially Step by Step Break Down screen images for a choreographed sequence, as seen from stage front (the “audience view”), according to a preferred embodiment of the system of my invention.

FIG. 10D provides an exemplary screen shot from the Step by Step Break Down screen images for a choreographed sequence, as seen from stage back (the “stage view”), according to a preferred embodiment of the system of my invention.

### DETAILED DESCRIPTION OF THE INVENTION

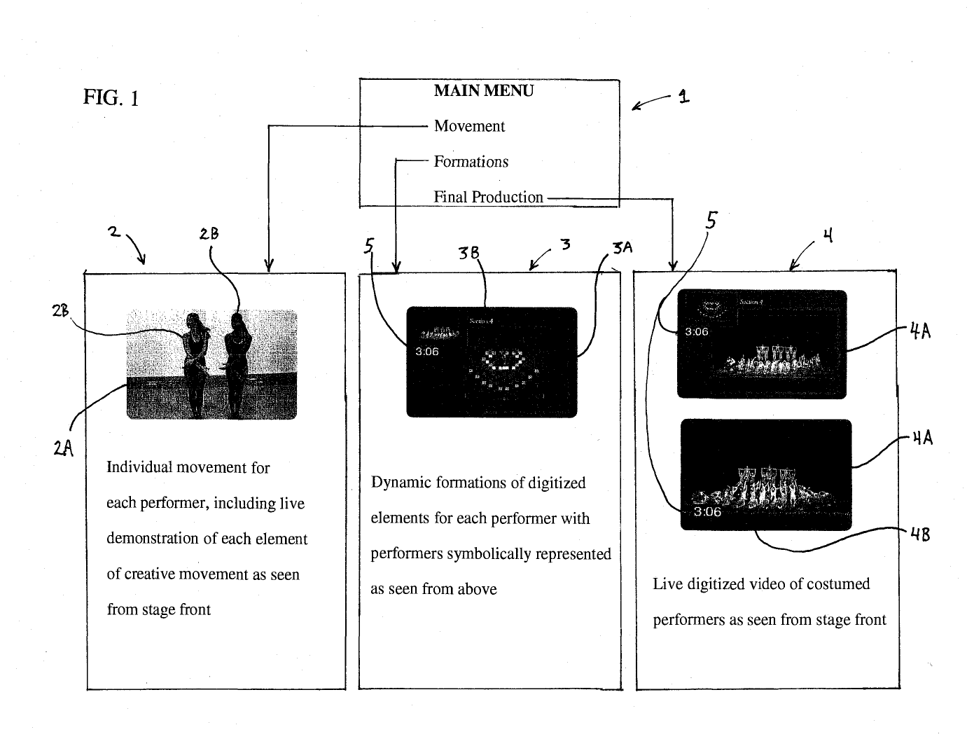

In its simplest embodiments, the system of my invention includes a data storage medium such as a video disk/DVD allowing storage of and access to sound recordings via speakers or headphones, and video images accessible via a screen display such as a television or computer monitor. The sound recordings include music and the video images include moving video images of choreographed dance movements performed to, or intended for performance to, said music. As illustrated in FIG. 1, a software menu function 1 can integrate and link an image section 2 (containing images for step-by-step demonstrations), an image section 3 (providing moving images for the performance as seen from above), and an image section 4 (providing moving images for the performance as seen from stage front) to the time of the music through digital “assignments” of elements within each screen image section 2, 3, and 4.

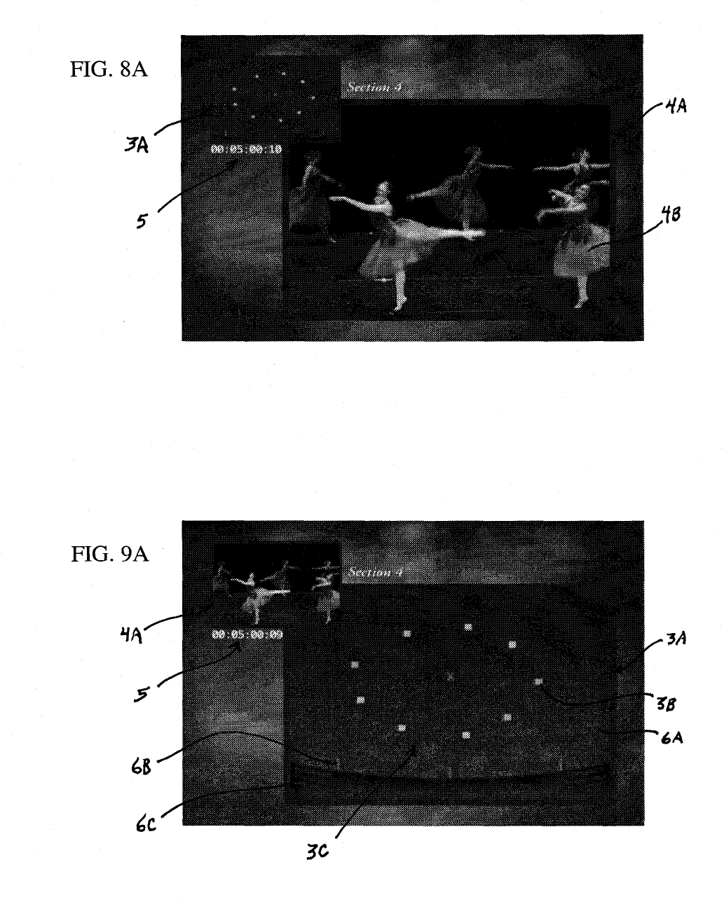

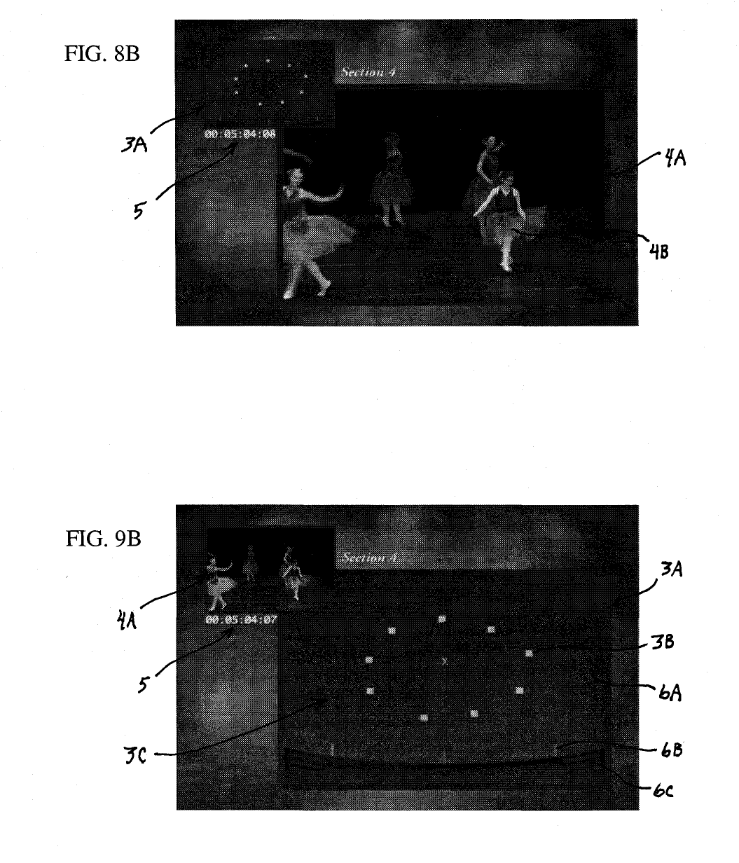

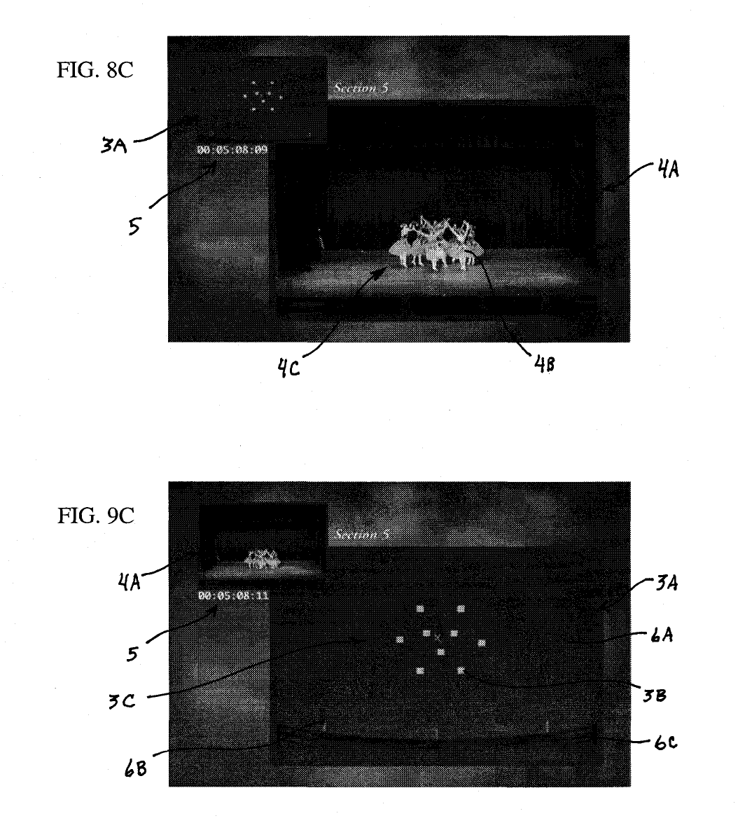

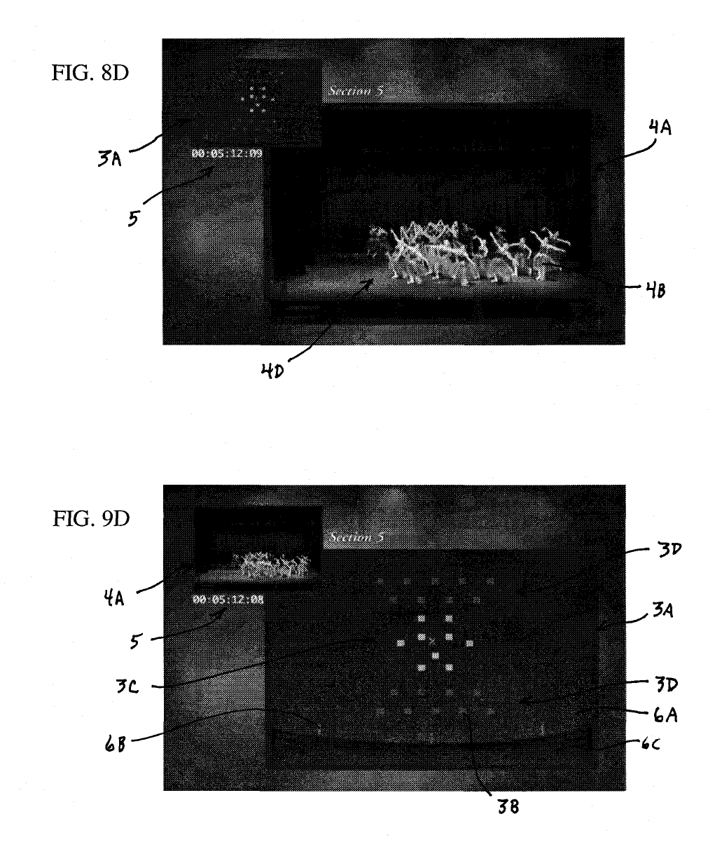

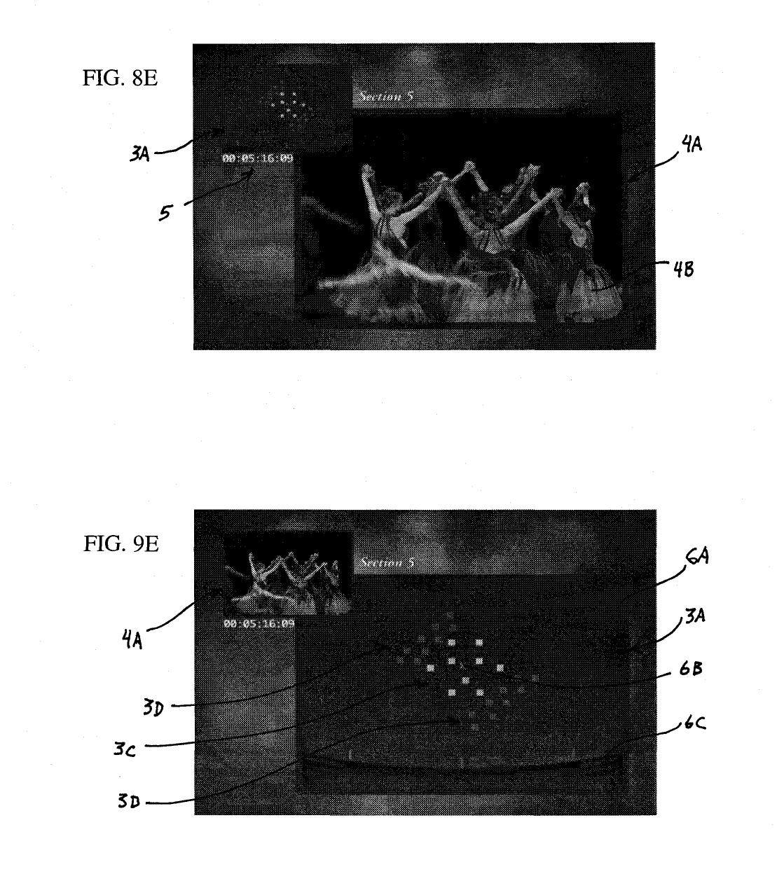

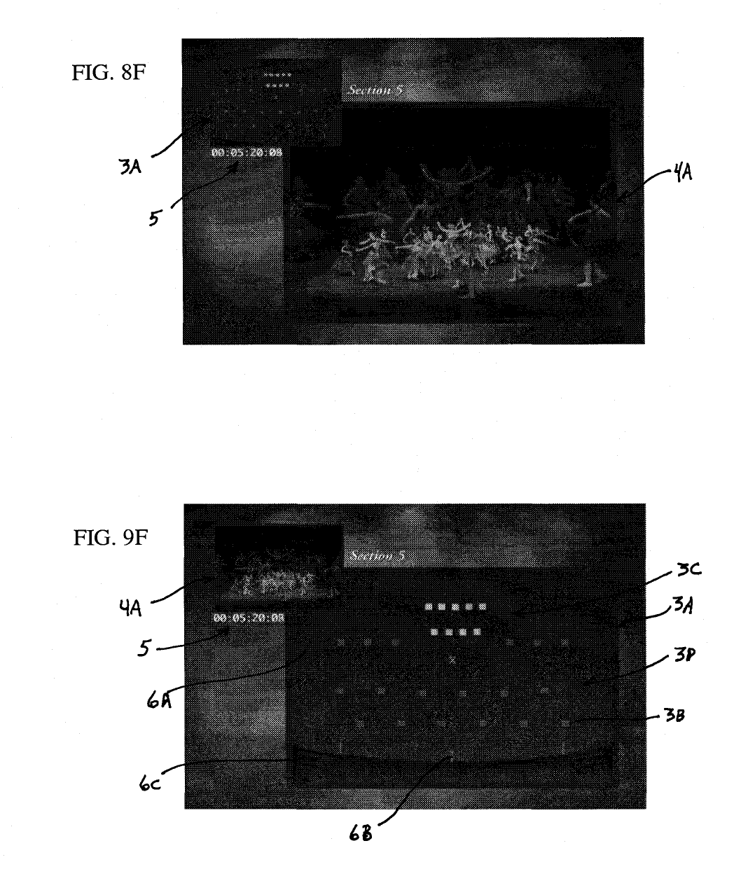

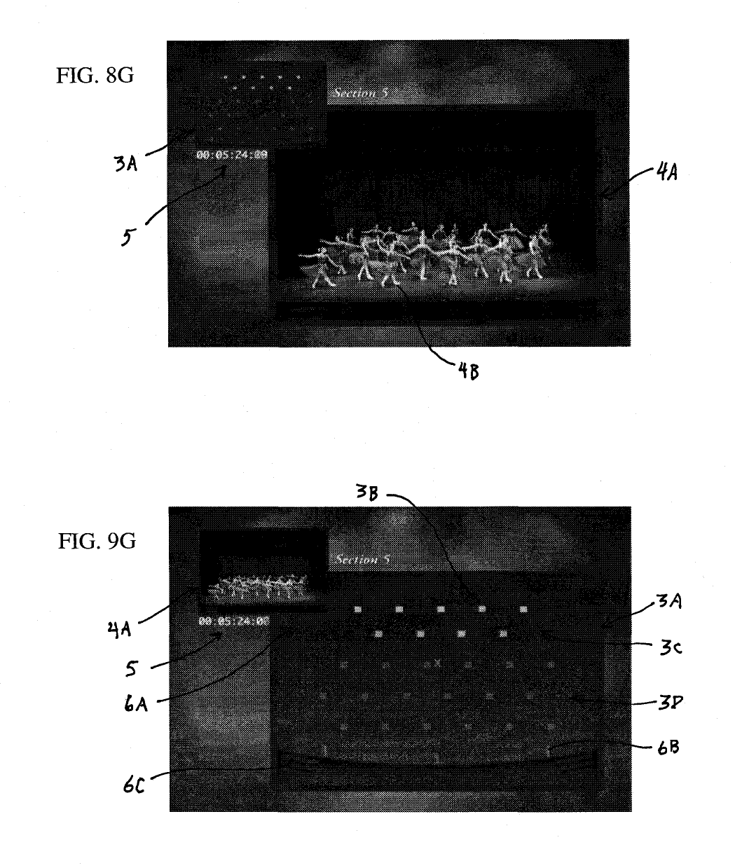

As discussed in more detail below, this system allows the user to find/stop the screen image for, e.g., image section 3 or 4 at any time mark 5 and review the same section on another screen to see the matching movement at that same time mark 5. For example, the user could be viewing the costumed performers 4B at live screen 4A, stop that section, note the time, then click to the formations screen 3A and see where every performer should be positioned via a schematic symbol 3B at that exact time. In addition, the user can access screen section 2 in order to see individual movements for each performer 4B in live screen 2A (where the performers are designated 2B). (Further, by optionally overlaying screens as illustrated in FIGS. 8A through 9G, the software allows the user to see formations and costumed performer movement in total coordination).

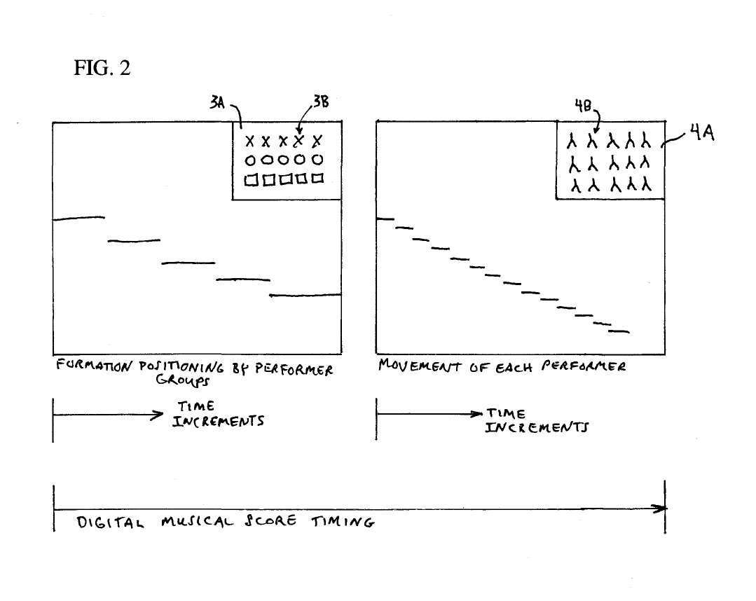

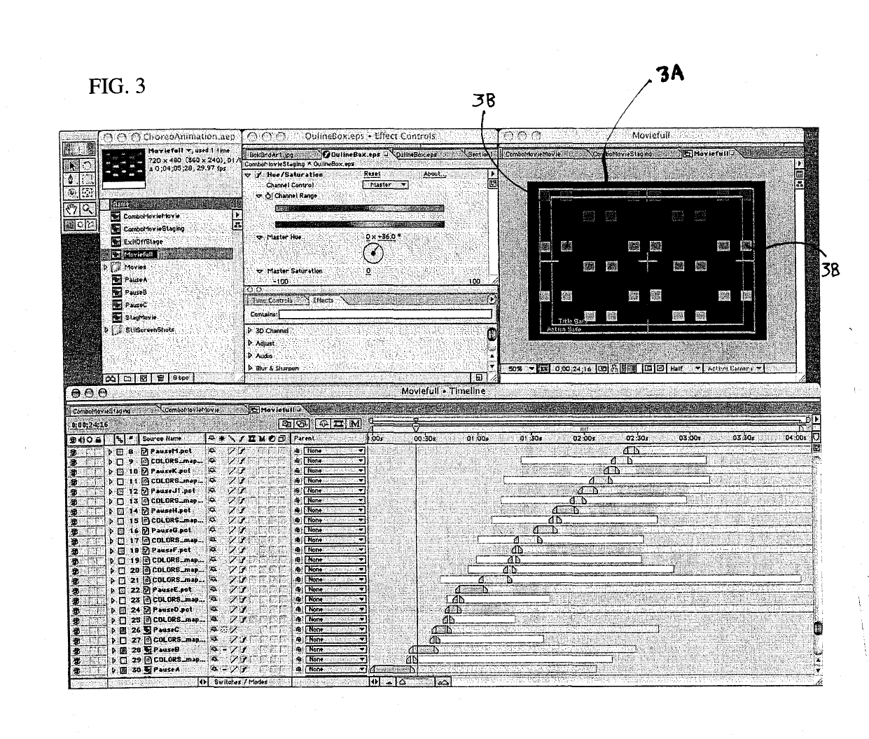

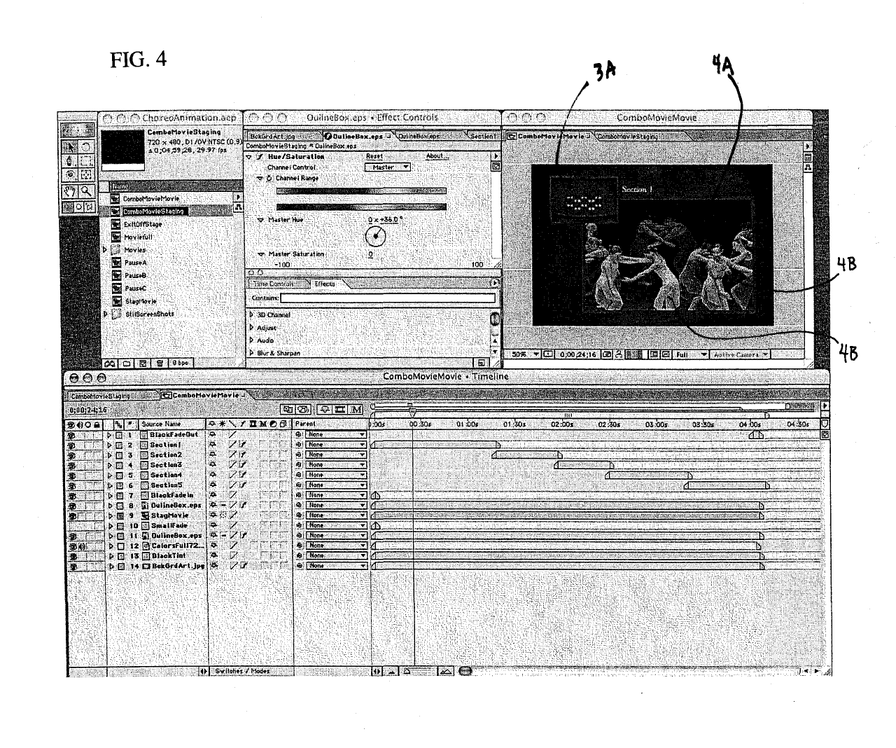

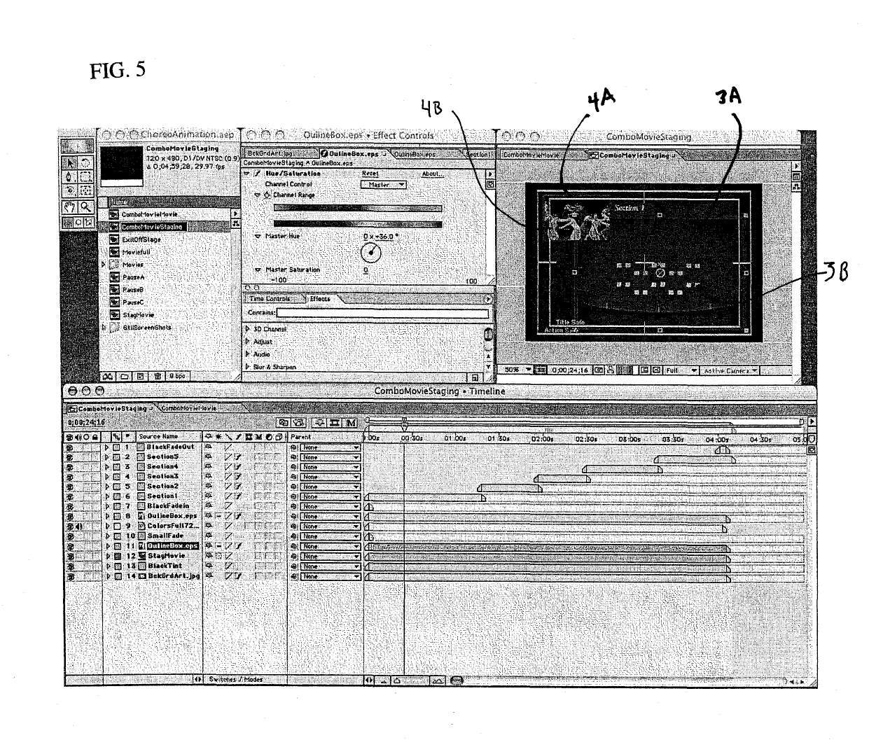

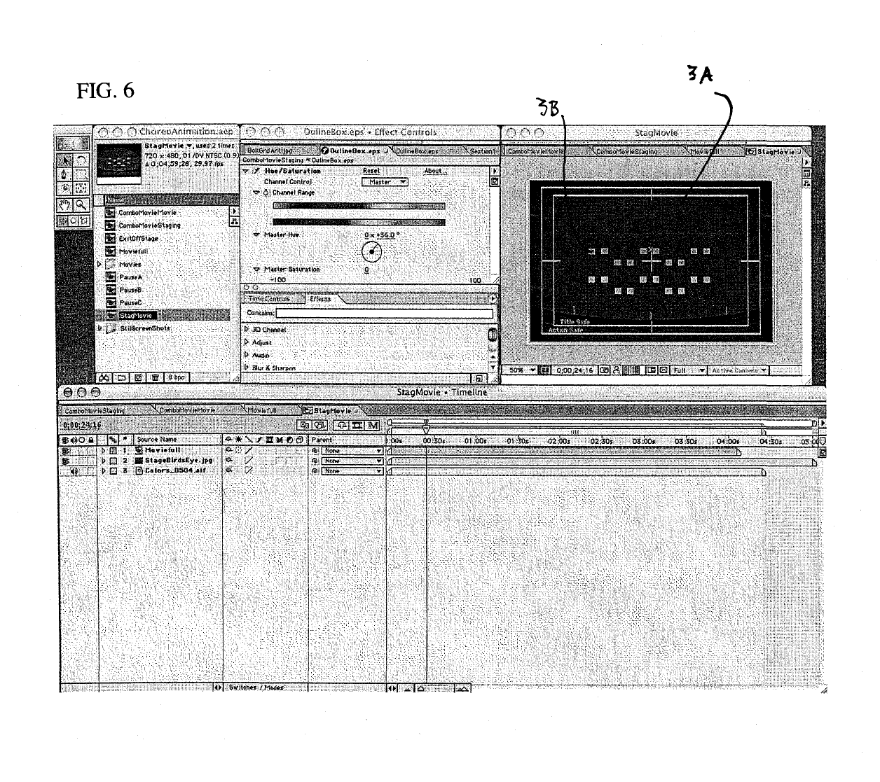

Turning to FIGS. 2 through 6, it will be noted that my invention defines each element of time for formations and for creative movements. The time elements are electronically matched through an overlay, using Adobe “After Effects” software. The formations are digitally created by using Macro Media “Director” software. The invention integrates these two digital pieces through the use of the timing of the uniquely created digital musical score. All screens in the final DVD are then viewable as discreet elements of time.

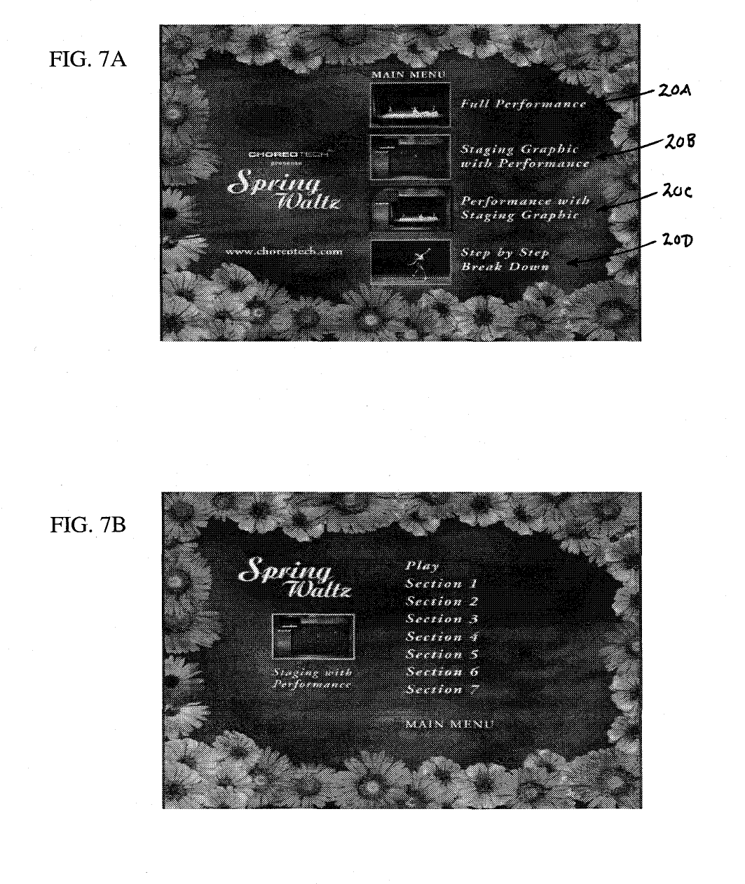

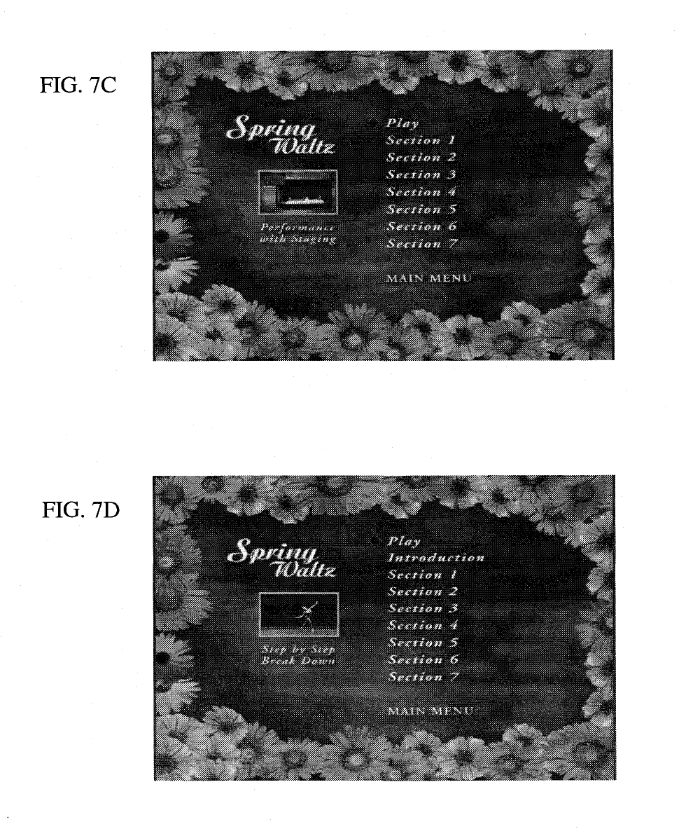

The general overview provided above is complemented by the more detailed overview of the implementation and operation of a preferred embodiment of my invention provided in FIGS. 7A through 10D. As illustrated generally in the formation screen display 3A constituting the main screen image of FIGS. 9A through 9G (and the sub-screen image of FIGS. 8A through 8G) moving video images accessed via the screen display include moving images portraying movements of the dancer(s) 3B, 3C, 3D to music as seen from above that provide an overview of the movement of a dancer 3B or a group of dancers 3C, 3D in relation to each other and the stage as the production proceeds in time to the music. As will be noted, these images are presented on a curved (or “stage shaped”) back-drop image 6A with markings 6B for stage positions (such as stage left, stage right, and center stage) and steps 6C. The images seen from above are preferably presented by moving icons, as illustrated in the above-referenced drawing figures, but could also be taken from a live performance, could be animated, and/or could be computer generated figure images. The icons themselves can take any form convenient for the purposes of the invention, meaning any form that efficiently conveys the information desired on position and dancer to the viewer). Thus, in the above-referenced drawing figures, the icons are colored squares and the color of the icon replicates and represents the color of the clothing worn by the dancer represented. However, these icons could also indicate dancer and group distinctions based on shape, as indicated in FIG. 2, or on the basis of both shape and color.

In preferred embodiments, the system of my invention includes a clock image providing time increments related to the performance (also referred to as a time mark 5), and performance images as seen from stage front which, once again, show the movement of a dancer or a group of dancers in relation to each other and the stage as the production proceeds in time to the music. Exemplary performance images from stage front (“audience view”) are provided in the live screen display 4A that constitutes the main screen image of FIGS. 8A through 8G (and the sub-screen images of FIGS. 9A through 9G). These moving video images, like those previously discussed, portray movements of the dancer(s) 4B, 4C, 4D to the music as seen by the audience in relation to each other and the stage as the production proceeds in time to the music. (The performance images from stage front are preferably taken from a live performance as illustrated, but could also, e.g., be animated and/or computer generated figure images).

The screen display can provide moving images portraying movements of the dancer(s) to music as seen from above 3B and moving images portraying movements of the dancer(s) from stage front 4B separately or simultaneously. However, as illustrated with respect to the preferred embodiment discussed herein, I have found that the best arrangement in terms of meeting the goals of the invention is to provide the viewer/user the option to view (i) the performance/live screen images as seen from stage front as the sole screen image, (ii) the performance/live images from above 3A as the main screen image with the performance/live screen images from stage front 4A as a sub-screen image being simultaneously presented (as illustrated in FIGS. 9A through 9G), or (ii) the performance images from stage front 4A as the main screen image with the images from above 3A as a sub-screen image being simultaneously presented (as illustrated in FIGS. 8A through 8G).

Thus, as illustrated in the exemplary sequence provided by FIGS. 8A through 8G (and corresponding FIGS. 9A through 9G) a group of dancers (indicated generally by arrows 3C, 4C) are shown performing choreographed dance movements at a time mark beginning at 5 minutes and 00 seconds (FIGS. 8A and 9A). They progress through continuing choreographed dance movements through FIGS. 8C and 9C (of which snap shots at approximate 4 second intervals are presented in FIGS. 8B, 8C, 9B, and 9C), and are joined by a second group of dancers 3D, 4D in contrasting color in FIGS. 8D and 9D, at a time mark of approximately 5 minutes and 12 seconds. These two groups 3C, 4C and 3D, 4D continue to perform choreographed dance movements through FIGS. 8G and 9G, with such movements being represented in these drawing figures by screen shots taken at approximate 4 second intervals.

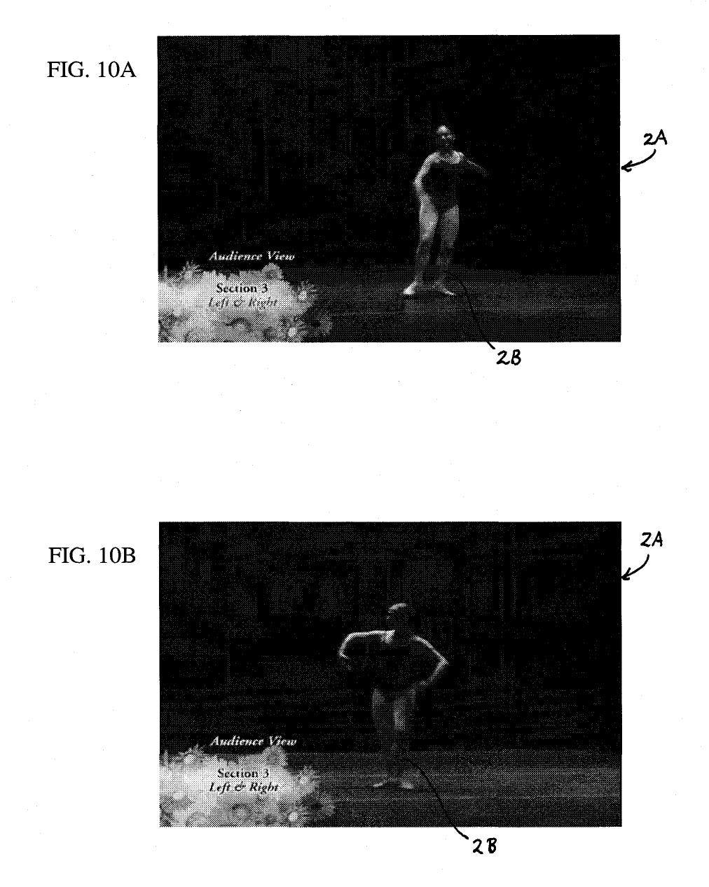

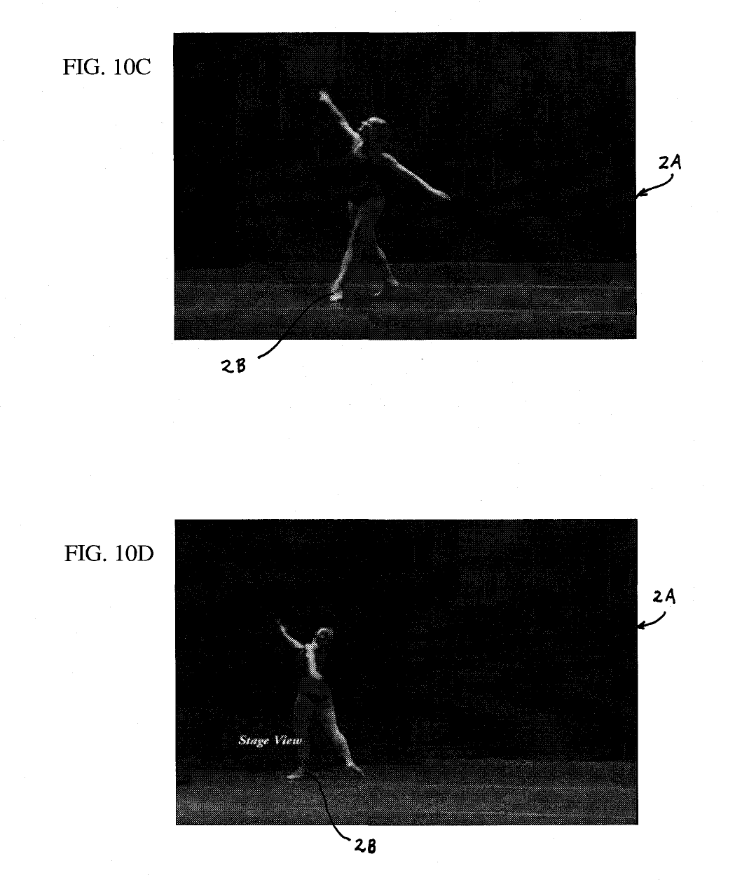

I also find it advantageous to provide an option to view moving step-by-step demonstration images 2A demonstrating particular dance moves and particular dance sequences performed by a dancer or dancers 2B, with said moves and sequences being provided from either or both stage front and stage back as illustrated in FIGS. 10A through 10D. (The latter option is of particular benefit to teachers and supervisors who must be familiar with the appearance of moves and sequences both from the rear and from stage front).

Selection of and movement between these various options offered by my invention is facilitated by provision of a menu image accessible via said screen display (as exemplified in FIG. 7A), with said menu image containing links 20A-2D for playing the performance 20A, accessing a sub-menu for Staging Graphic with Performance 20B, accessing a sub-menu for Performance with Staging Graphic 20C, and accessing a sub-menu for Step by Step Break Down 20D. The sub-menu for Staging Graphic with Performance (as illustrated in FIG. 7B) likewise provides links for accessing said images (as illustrated and discussed above with reference to FIGS. 9A through 9G). The sub-menu for Performance with Staging Graphic with Performance (as illustrated in FIG. 7C) likewise provides links for accessing said images (as illustrated and discussed above with reference to FIGS. 8A through 8G). And, the sub-menu for Step by Step Breakdown (as illustrated in FIG. 7D) likewise provides links for accessing said images (as illustrated and discussed above with reference to FIGS. 10A through 10D).

In the preferred embodiment illustrated, the latter three sub-menus, as illustrated in FIGS. 7B through 7D, allow the user to select particular sections of the work for review and allow easy switching between screen options for the purposes of this invention. Thus, a user who is interested in viewing the movements of dancers 3B, 4B in a particular sequence in, e.g., “Section 3” of a work from above can select the optional screen where images from above are the primary screen image from the main menu (i.e., by selecting 20B in the screen illustrated in FIG. 7A) and then select “Section 3” from the sub-menu (as illustrated in FIG. 7B) for that screen option. If the user then wishes to see particular movements and sequences demonstrated by individual dancers 2B in detail, for, e.g., pedagogical purposes, the user can return to the main menu (FIG. 7A), choose the step-by-step screen option 20D, and then choose the same section on the step-by-step screen menu (FIG. 7D).

As the foregoing makes clear, my invention solves the problem of creating “portable choreography” which has been packaged into a readily usable format in the end product. However, numerous changes are possible without exceeding the scope of the inventive concept. Accordingly, it is to be understood that the embodiments of the invention herein described are merely illustrative of the application of the principles of the invention. Reference herein to details of the illustrated embodiments is not intended to limit the scope of the claims when filed, which will themselves recite those features regarded as essential to the invention.

What is claimed is:

1. A choreography recording and access system, comprising:
a) a data storage medium, said data storage medium allowing storage of and access to sound recordings, said recordings including music, and to video images via a screen display, said images including moving video images;
b) wherein said moving video images accessed via said screen display can include moving icon images portraying movements of at least one dancer to music.

2. A choreography recording and access system as described in claim 1, wherein said icon images portray movements of said at least one dancer on a stage as seen from above.

3. A choreography recording and access system as described in claim 1, wherein said at least one dancer is a plurality of dancers performing contemporaneously and said icon images portray movements of said plurality of dancers on a stage as seen from above.

4. A choreography recording and access system as described in claim 1, wherein said screen display can further include live performance images from stage front, said live performance images portraying the same movements of said at least one dancer being simultaneously portrayed by said icon images from above.

5. A choreography recording and access system as described in claim 1, wherein said moving video images further include step-by-step demonstration images demonstrating at least one of: particular dance moves and particular dance sequences performed by said at least one dancer, and which particular dance moves and particular dance sequences can be viewed from at least one of stage front and stage back.

6. A choreography recording and access system as described in claim 4, wherein said moving video images further include step-by-step demonstration images demonstrating at least one of: particular dance moves and particular dance sequences performed by said at least one dancer, and which particular dance moves and particular dance sequences can be viewed from at least one of stage front and stage back.

7. A choreography recording and access system as described in claim 4, further including a menu image accessible via said screen display, said menu image containing links for accessing at least one of said live performance images, said icon images, and both live performance images and icon images simultaneously via said screen display.

8. A choreography recording and access system as described in claim 6, further including a menu image accessible via said screen display, said menu image containing links for accessing at least one of said live performance images, said icon images, both live performance images and icon images simultaneously, and said step-by-step demonstration images via said screen display.

9. A choreography recording and access system as described in claim 1, wherein said screen display further includes a clock conveying time increments in said performance.

10. A choreography recording and access system as described in claim 4, wherein said screen display further includes a clock conveying time increments in said performance.

11. A choreography recording and access system, comprising:
a) a data storage medium, said data storage medium allowing storage of and access to sound recordings, said recordings including music, and to video images via a screen display, said images including moving video images;
b) wherein said moving video images accessed via said screen display include moving images portraying movements of at least one dancer as seen from above to music;
c) wherein said screen display includes live performance images from stage front, said live performance images portraying the same movements of said at least one dancer being simultaneously portrayed by said moving images from above; and
d) wherein said screen display further includes a clock display conveying time increments in said performance.

12. A choreography recording and access system as described in claim 11, wherein said at least one dancer is a plurality of dancers performing contemporaneously.

13. A choreography recording and access system as described in claim 11, wherein said moving images portraying movements of said at least one dancer as seen from above are moving icon images.

14. A choreography recording and access system as described in claim 13, wherein said at least one dancer is a plurality of dancers performing contemporaneously and said icon images portray movements of said plurality of dancers on a stage as seen from above.

15. A choreography recording and access system as described in claim 11, wherein said moving video images further include step-by-step demonstration images demonstrating at least one of: particular dance moves and particular dance sequences performed by said at least one dancer, and which particular dance moves and particular dance sequences can be viewed from at least one of stage front and stage back.

16. A choreography recording and access system as described in claim 11, further including a menu image accessible via said screen display, said menu image containing links for accessing at least one of said live performance images, said images from above, and both live performance images and images from above simultaneously via said screen display.

17. A choreography recording and access system as described in claim 15, further including a menu image accessible via said screen display, said menu image containing links for accessing at least one of said live performance images, said images from above, both live performance images and images from above simultaneously, and said step-by-step demonstration images via said screen display.

18. A choreography recording and access system as described in claim 16, wherein said images from above are icon images.

19. A choreography recording and access system as described in claim 17, wherein said images from above are icon images.

20. A choreography recording and access system as described in claim 19, wherein said at least one dancer is a plurality of dancers performing contemporaneously.
